(19) United States
(12) Patent Application Publication
(10) Pub. No.: US 2018/0095699 A1
(43) Pub. Date: Apr. 5, 2018

(54) MEMORY SYSTEM, MEMORY DEVICE THEREOF, AND METHOD FOR WRITING TO AND READING FROM MEMORY DEVICE THEREOF

(71) Applicant: National Tsing Hua University, Hsinchu City (TW)

(72) Inventors: Ren-Shuo LIU, Hsinchu City (TW); Jian-Hao HUANG, Hsinchu City (TW)

(73) Assignee: National Tsing Hua University, Hsinchu City (TW)

(21) Appl. No.: 15/718,738

(22) Filed: Sep. 28, 2017

Related U.S. Application Data
(60) Provisional application No. 62/403,080, filed on Oct. 1, 2016.

(51) Int. Cl. G06F 3/06

(52) U.S. Cl. CPC G06F 3/0659; G06F 3/0656; G06F 3/0679; G06F 3/0611

(57) ABSTRACT

A memory system includes a memory device, a channel and a memory controller device. The memory device includes: a memory array having a read latency, and a write latency that is longer than the read latency; a buffer for two-way data transfer with the memory array; and a transceiver for two-way data transfer with the buffer. The memory controller device is for two-way data transfer with the transceiver through the channel. The memory controller device transmits write data at a write bandwidth for receipt by the transceiver. The transceiver transmits read data at a read bandwidth that is greater than the write bandwidth for receipt by the memory controller device.

### CROSS-REFERENCE KS RELATED APPLICATION

This application claims priority of U.S. Provisional Patent Application No. 62/403080, filed on Oct. 1, 2016.

### FIELD

The disclosure relates to a memory system, and more particularly to a memory system that performs asymmetric two-way data transfer, to a memory device thereof, and to a method for writing to and reading from a memory device thereof.

### BACKGROUND

A conventional memory system that includes a memory array with asymmetric write and read latencies disadvantageously has low data transfer efficiency.

### SUMMARY

Therefore, an object of the disclosure is to provide a memory system that can alleviate the drawback of the prior art a memory device thereof, and a method for writing to and reading from a memory device thereof.

According to an aspect of the disclosure, the memory system, includes a memory device, a channel and a memory controller device. The memory device includes a memory array, a buffer and a transceiver. The memory array has a read latency, and a write latency that is longer than the read latency. The buffer is coupled to the memory array for two-way data transfer therewith. The transceiver is coupled to the buffer for two-way data transfer therewith. The channel is coupled to the transceiver. The memory controller device is coupled to the channel for two-way data transfer with the transceiver therethrough. The memory controller device transmits write data at a write bandwidth for receipt by the transceiver when the memory controller device is to write the write data to the memory device. The transceiver transmits read data at a read bandwidth that is greater than the write bandwidth for receipt by the memory controller device when the memory controller device is to read the read data from the memory device.

According to another aspect of the disclosure, the memory device is used to be coupled to a channel that is coupled to a memory controller device. The memory device includes a memory array, a buffer and a transceiver. The memory array has a read latency, and a write latency that is longer than the read latency. The buffer is coupled to the memory array for two-way data transfer therewith. The transceiver is coupled to the buffer for two-way data transfer therewith, and is used to be coupled further to the channel for two-way data transfer with the memory controller device therethrough. The transceiver receives write data from the memory controller device at a write bandwidth when the memory controller device is to write the write data to the memory device, and transmits read data to the memory controller device at a read bandwidth that is greater than the write bandwidth when the memory controller device is to read the read data from the memory device.

According to yet another aspect of the disclosure, there is provided the method for writing to and reading from a memory device using a memory controller device. The memory device includes a memory array. The memory array has a read latency, and a write latency that is longer than the read latency. The method includes steps of: transmitting, by the memory controller device, write data to the memory device at a write bandwidth when the memory controller device is to write the write data to the memory device; and receiving, by the memory controller device, read data from the memory device at a read bandwidth that is greater than the write bandwidth when the memory controller device is to read the read data from the memory device.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a first embodiment of a memory system according to the disclosure;

FIG. 2 is a circuit block diagram illustrating an exemplary implementation of the first embodiment;

FIG. 3 is a timing diagram illustrating operation of the exemplary implementation of the first embodiment;

FIG. 4 is a flow chart illustrating a method performed by the exemplary implementation of the first embodiment;

FIG. 5 is a block diagram illustrating a second embodiment of the memory system according to the disclosure;

FIG. 6 is a block diagram illustrating a third embodiment of the memory system according to the disclosure;

FIG. 7 is a block diagram illustrating a fourth embodiment of the memory system according to the disclosure;

FIG. 8 is a block diagram illustrating a fifth embodiment of the memory system according to the disclosure; and

FIG. 9 is a block diagram illustrating a sixth embodiment of the memory system according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

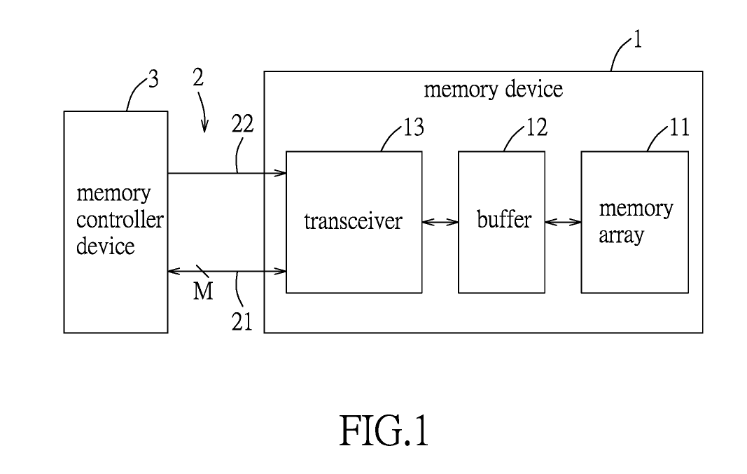

Referring to FIG. 1, a first embodiment of a memory system according to the disclosure includes a memory device a channel 2 and a memory controller device 3. The memory device 1 includes a memory array 11, a buffer 12 and a transceiver 13. The memory array 11 has a read latency of Q ns, and a write latency of P ns that is longer than the read latency (i.e., P>Q). The buffer 12 is coupled to the memory array 11 for two-way data transfer therewith. The transceiver 13 is coupled to the buffer 12 for two-way data transfer therewith. The channel 2 is coupled to the transceiver 13. The memory controller device 3 is coupled to the channel 2 for two-way data transfer with the transceiver 13 therethrough. The memory controller device 3 transmits write data at a write bandwidth of BWw MB/s for receipt by the transceiver 13 when the memory controller device 3 is to write the write data to the memory device 1. The transceiver 13 transmits read data at a read bandwidth of BWr MB/s that is greater than the write bandwidth (i.e., BWr>BWw) for receipt by the memory controller device 3 when the memory controller device 3 is to read the read data from the memory device 1. In this embodiment, the write latency is at least twice the read latency (i.e., P≧2×Q.), and the read bandwidth is at least twice the write bandwidth (i.e., BWr≧2×BWw). For example, the memory array 11 may be a NAND flash memory array (where a ratio of the write latency to the read latency may be greater than or equal to ten (i.e., P/Q≧10)), a magnetoresistive random access memory (MRAM) array (where the ratio of the write latency to the read latency may be greater than or equal to three (i.e., P/Q≧3)), a phase change memory (PCM) array (where the ratio of the write latency to the read latency may be greater than or equal to two (i.e., P/Q≧2)), a resistive random access memory (ReRAM) array (where the ratio of the write latency to the read latency may be greater than or equal to five (i.e., P/Q≧5)), or the like; and a ratio of the read bandwidth to the write bandwidth (i.e., BWr/BWw) may be one of the following: two; greater than two and less than three; three; greater than three and less than four; and so on.

In this embodiment, the channel 2 includes a parallel common bus 21 that is a number (M) of bits wide, where M is an integer greater that one (i.e., M>1), and both the write data and the read data are transmitted through the parallel common bus 21. That is to say, each of the write data and the read data is transmitted a number (M) of bits at a time. In addition, the memory controller device 3 transmits the write data at a write frequency of Fw MHz (i.e., Fw=BWw×8/M), and the transceiver 13 transmits the read data at a read frequency of Fr MHz (i.e., Fr=BWr×8/M) that is at least twice the write frequency (i.e., Fr≧2×Fw).

Moreover, the memory controller device 3 further transmits a write clock signal and a read clock signal for receipt by the transceiver 13; the memory controller device 3 transmits the write data in synchronization with the write clock signal by using one of single data rate (SDR) signaling, double data (DDR) signaling and quad data rate (QDR) signaling; and the transceiver 13 transmits the read data in synchronization with the read clock signal by using one of SDR signaling, DDR signaling and QDR signaling. The write clock signal has a frequency that equals the write frequency when SDR signaling is used by the memory controller device 3, that equals half the write frequency when DDR signaling is used by the memory controller device 3, and that equals a quarter of the write frequency when QDR signaling is used by the memory controller device 3. The read clock signal has a frequency that equals the read frequency when SDR signaling is used by the transceiver 13, that equals half the read frequency when DDR signaling is used by the transceiver 13, and that equals a quarter of the read frequency when QDR signaling is used by the transceiver 13.

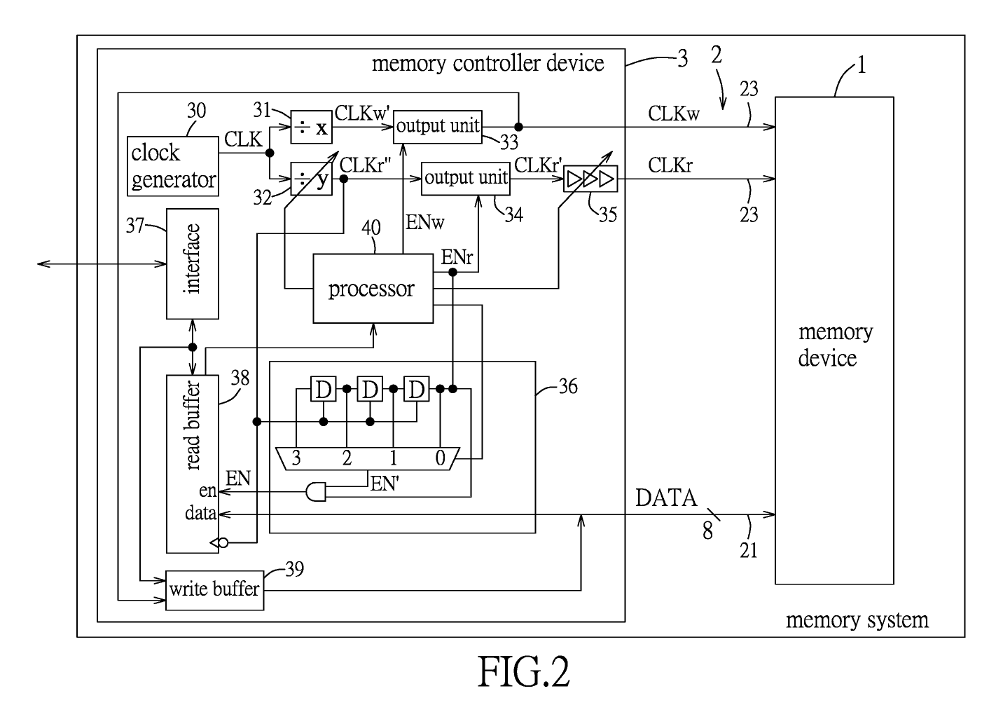

It should be noted that the memory controller device 3 and the transceiver 13 may transmit the write data and the read data by using one of single-ended signaling and differential signaling. The parallel common bus 21 includes a number (M) of conductors (not shown) when single-ended signaling is used by the memory controller device 3 and the transceiver 13, and includes a number (M) of pairs of conductors (not shown) when differential signaling is used by the memory controller device 3 and the transceiver 13. In addition, the channel 2 may further include a conductor 22, through which the write clock signal and the read clock signal are transmitted, as shown in FIG. 1. Alternatively, the channel 2 may further include two conductors 23, through which the write clock signal and the read clock signal are respectively transmitted, as shown in FIG. 2.

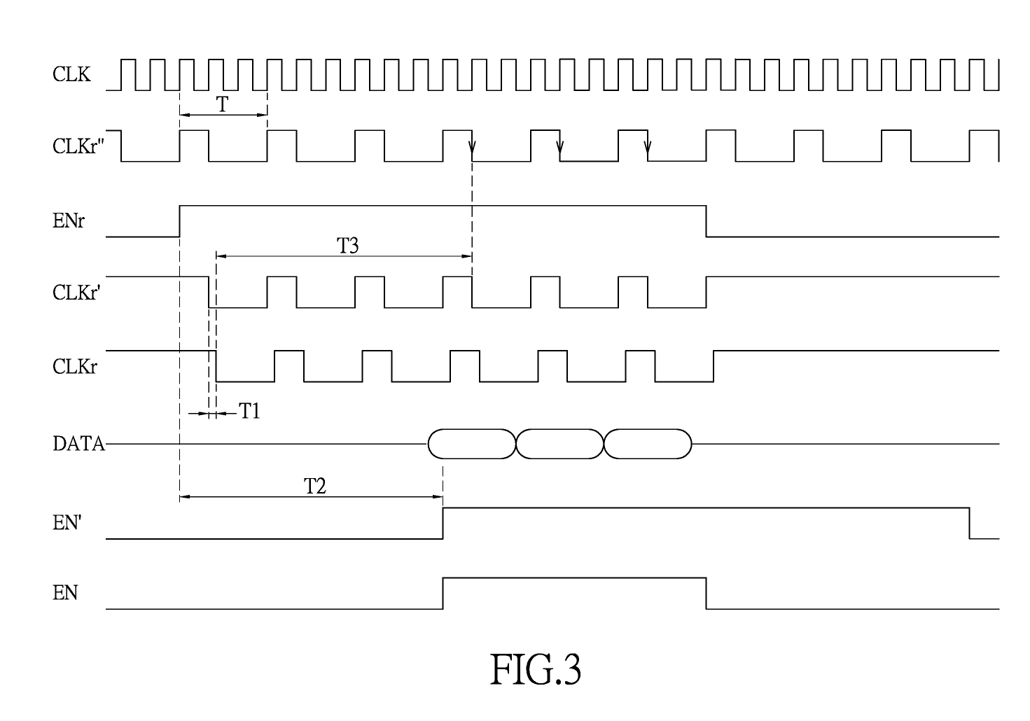

Referring to FIGS. 2 and 3, in an exemplary implementation of the first embodiment, M=8, the write clock signal (CLKw) and the read clock signal (CLKr) are respectively transmitted through the conductors 23, the memory controller device 3 transmits the write data in synchronization with the write clock signal (CLKw) by using SDR signaling, and the memory device 1 transmits the read data in synchronization with the read clock signal (CLKr) by using SDR signaling. In addition, the memory controller device 3 includes a clock generator 30, two frequency dividers 31, 32, two output units 33, 34, a fine offset unit 35, a coarse offset unit 36, an interface 37, a read buffer 38, a write buffer 39 and a processor 40.

The clock generator 30 generates a clock signal (CLK).

The frequency divider 31 is coupled to the clock generator 30 for receiving the clock signal (CLK) therefrom, and divides a frequency of the clock signal (CLK) by a number (x) to generate a clock signal (CLKw′).

The frequency divider 32 is coupled to the clock generator 30 for receiving the clock signal (CLK) therefrom, and divides the frequency of the clock signal (CLK) by a variable number (y) that is at most half the number (x) (i.e., y<0.5×x) to generate a clock signal (CLKr″). It should be noted that FIG. 3 illustrates a circumstance where y=3.

The output unit 33 is coupled to the frequency divider 31 for receiving the clock signal (CLKw′) therefrom, further receives an enable signal (ENw) having a logic level that is switchable between a logic high level and a logic low level, and is coupled further to a first one of the conductors 23 (also referred to as the first conductor 23). The output unit 33 generates, based on the clock signal (CLKw′) and the enable signal (ENw), the write clock signal (CLKw) for receipt by the memory device 1 through the first conductor 23. The clock signal (CLKw) is substantially identical to the clock signal (CLKw′) when the enable signal (ENw) is at the logic high level, and is at the logic high level when the enable signal (ENw) is at the logic low level.

The output unit 34 is coupled to the frequency divider 32 for receiving the clock signal (CLKr″) therefrom, further receives an enable signal (ENr) having a logic level that is switchable between the logic high level and the logic low level, and generates a clock signal (CLKr′) based on the clock signal (CLKr″) and the enable signal (ENr). The clock signal (CLKr′) is substantially identical to the clock signal (CLKr″) when the enable signal (ENr) is at the logic high level, and is at the logic high level when the enable signal (ENr) is at the logic low level.

The fine offset unit 35 is coupled to the output unit 34 for receiving the clock signal (CLKr′) therefrom, and is coupled further to a second one of the conductors 23 (also referred to as the second conductor 23). The fine offset unit 35 delays the clock signal (CLKr′) by a variable fine offset (T1) (which is greater than or equal to zero and is less than a period (T) of the clock signal (CLKr″) (i.e., 0≦T1≦T)) to generate the read clock signal (CLKr) for receipt by the memory device 1 through the second conductor 23. It should be noted that FIG. 3 illustrates a circumstance where T1≠0.

The coarse offset, unit 36 is coupled to the frequency divider 32 for receiving the clock signal (CLKr″) therefrom, and further receives the enable signal (ENr). The coarse offset unit 36 delays the enable signal (ENr) by a variable coarse off set (T2) (which equals s×T, where s denotes an integer within a range of from zero to three) to generate an enable signal (EN′), and generates an enable signal (EN) that is a result of an AND operation of the enable signals (ENr, EN′). It should be noted that FIG. 3 illustrates a circumstance where T2=3×T.

The interface 37 is used to be coupled to, for example, a host (not shown) for two-way data transfer therewith. For example, the interface 37 may be a SATA 3.0 interface, a USB 3.0 interface, or the like .

The read buffer 38 is coupled to the interface 37 for transmitting data thereto, is coupled further to the parallel common bus 21 for receiving the read data from the memory device 1 therethrough, and is coupled further to the frequency divider 32 and the coarse offset unit 36 for receiving the clock signal (CLKr″) and the enable signal (EN) respectively therefrom. The read buffer 38 latches the read data at the falling edges of the clock signal (CLKr″) when the enable signal (EN) is at the logic high level. In other words, when the enable signal (EN) is at the logic high level, at each falling edge of the clock signal (CLKr″), the read buffer 38 takes a sample of the read data and stores the same in the read buffer 38.

The write buffer 39 is coupled to the interface 37 for receiving data therefrom, is coupled further to the output unit 33 for receiving the write clock signal (CLKw) therefrom, and is coupled further to the parallel common bus 21. The write buffer 39 transmits the write data in synchronization with the write clock signal (CLKw) for receipt by the memory device I through the parallel common bus 21.

It should be noted that, in other implementations of the first embodiment, the read buffer 38 and the write buffer 39 may be integrated into a single buffer.

The processor 40 is coupled to the frequency divider 32, the output units 33, 34, the fine offset unit 35, the coarse offset unit 36 and the read buffer 38. The processor 40 generates the enable signal (ENw) for receipt by the output unit 33, generates the enable signal (ENr) for receipt by the output unit 34 and the coarse offset unit 36, and controls the number (y), the fine offset (T1) and the coarse offset (T2) that are used respectively by the frequency divider 32, the fine off set unit 35 and the coarse offset unit 36. The processor 40 switches the logic level of the enable signal (ENw) to the logic high level when the memory controller device 3 is to write the write data to the memory device 1, and switches the logic level of the enable signal (ENw) to the logic low level upon completion of the writing operation. The processor 40 switches the logic level of the enable signal (ENr) to the logic high level when the memory controller device 3 is to read the read data from the memory device 1, and switches the logic level of the enable signal (ENr) to the logic low level upon completion of the reading operation.

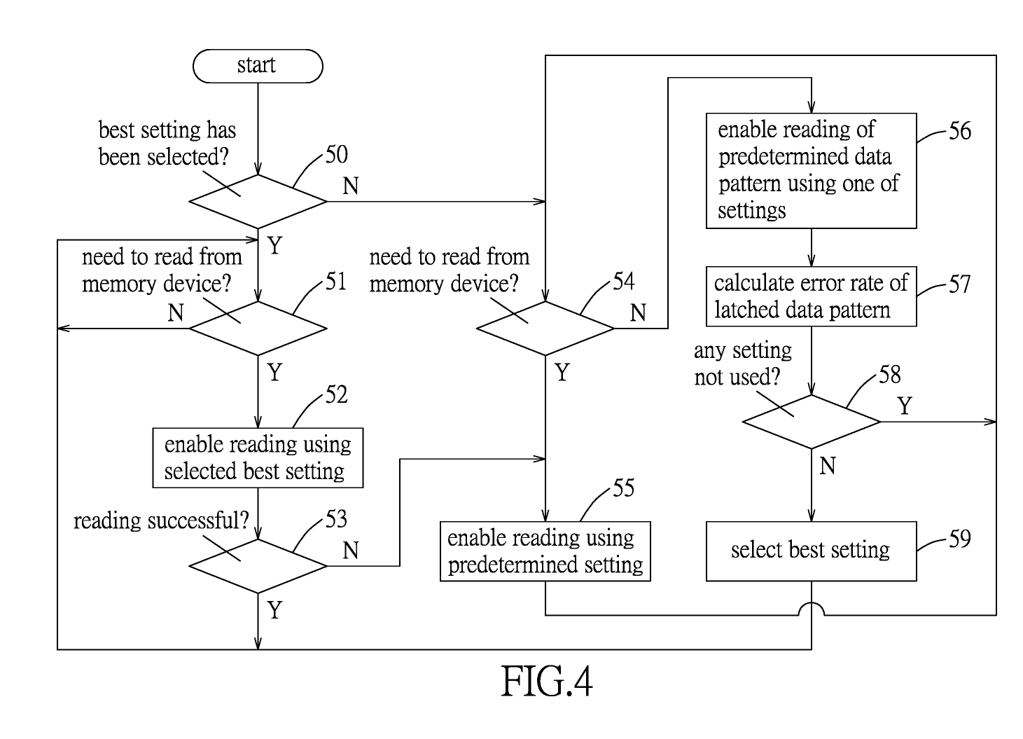

Referring to FIGS. 2, 3 and 4, the frequency of the read clock signal (CLKr) is determined by the number (y). Triggered at each falling edge of the read clock signal (CLKr) while the enable signal (ENr) is at the logic high level, transmission of the read data actually occurs at the time instant where the read latency elapses after each triggering while the enable signal (ENr) is still at the logic high level. For each transmission of the read data, the read buffer 38 latches the read data at a corresponding falling edge of the clock signal (CLKr″) when the enable signal (EN) is at the logic high level. For each instance of the read buffer 38 latching the read data, an offset (T3) thereof from the corresponding falling edge of the read clock signal (CLKr) on which the corresponding transmission of the read data is triggered is determined by the fine offset (T1) and the coarse offset (T2) (e.g., T3=T2−T1). For various settings of the frequency of the read clock signal (CLKr) and the offset (T3), the processor 40 performs a method shown in FIG. 4 to select one of the settings that is determined to make the latched read data have an insignificant error rate and to make transmission of the read data fastest, and to control the number (y), the fine offset (T1) and the coarse offset (T2) in such a way that the frequency of the read, clock signal (CLKr) and the offset (T3) are consistent with the selected setting. In an example, the read data is obtained by the transceiver 13 from encoding original read data for error correction, and the error rate is insignificant if it is less than a predetermined value (e.g., 1×10⁻⁴) that does not exceed a correctable error rate (e.g., 3×10⁻³)of the error correction.

In step 50, the processor 40 determines whether a best one of the settings has been selected. If affirmative, the flow proceeds to step 51. Otherwise, the flow goes to step 54. Initially, the processor 40 would determine that the best setting has not been selected.

In step 51, the processor 40 determines whether the memory controller device 3 is to read the read data from the memory device 1. If affirmative, the flow proceeds to step 52. Otherwise, the flow goes back to step 51.

In step 52, the processor 40 enables the reading of the read data using the selected best setting. First, to start the reading, the processor 40 makes the logic level of the enable signal (ENr) switch to the logic high level. Meanwhile, the processor 40 controls the number (y), the fine offset (T1) and the coarse offset (T2) in such a way that the frequency of the read clock signal (CLKr) and the offset (T3) are consistent with the selected best setting. Thereafter, the processor 40 makes the logic level of the enable signal (ENr) switch to the logic low level upon completion of the reading of the read data.

In step 53, the processor 40 determines whether the reading of the read data is successful. If affirmative, the flow goes back to step 51. Otherwise, the flow goes to step 55.

In step 54, the processor 40 determines whether the memory controller device 3 is to read the read data from the memory device 1. If affirmative the flow proceeds to step 55. Otherwise, the flow goes to step 56.

In step 55, the processor 40 enables the reading of the read data using a predetermined one of the settings. First, to start the reading, the processor 40 makes the logic level of the enable signal (ENr) switch to the logic high level. Meanwhile, the processor 40 controls the number (y), the fine offset (T1) and the coarse off set (T2) in such a way that the frequency of the read clock signal (CLKr) and the offset (T3) are consistent with the predetermined setting. Thereafter, the processor 40 makes the logic level of the enable signal (ENr) switch to the logic low level upon completion of the reading of the read data. After step 55, the flow goes back to step 54.

In step 56, the processor 40 enables reading of a predetermined data pattern using one of the settings. The predetermined data pattern is pre-stored in the buffer 12 (see FIG. 1) of the memory device 1, and is known to the processor 40. First, to start the reading, the processor 40 makes the logic level of the enable signal (ENr) switch to the logic high level. Meanwhile, the processor 40 controls the number (y), the fine offset (T1) and the coarse offset (T2) in such a way that the frequency of the read clock signal (CLKr) and the offset (T3) are consistent with said one of the settings. Thereafter, the processor 40 makes the logic level of the enable signal (ENr) switch to the logic low level upon completion of the reading of the predetermined data pattern.

In step 57, the processor 40 calculates an error rate of the data pattern latched in the read buffer 38 as compared to the predetermined data pattern.

In step 58, the processor 40 determines whether any one of the settings has not been used. If affirmative, the flow goes back to step 54. Otherwise, the flow proceeds to step 59.

In step 59, the processor 40 selects at least one of the settings, the error rate corresponding to each of which is less than the predetermined value (i.e., 1×10⁻⁴), and selects one of the at least one setting that has the highest frequency to serve as the best setting. Thereafter, the flow goes back to step 51.

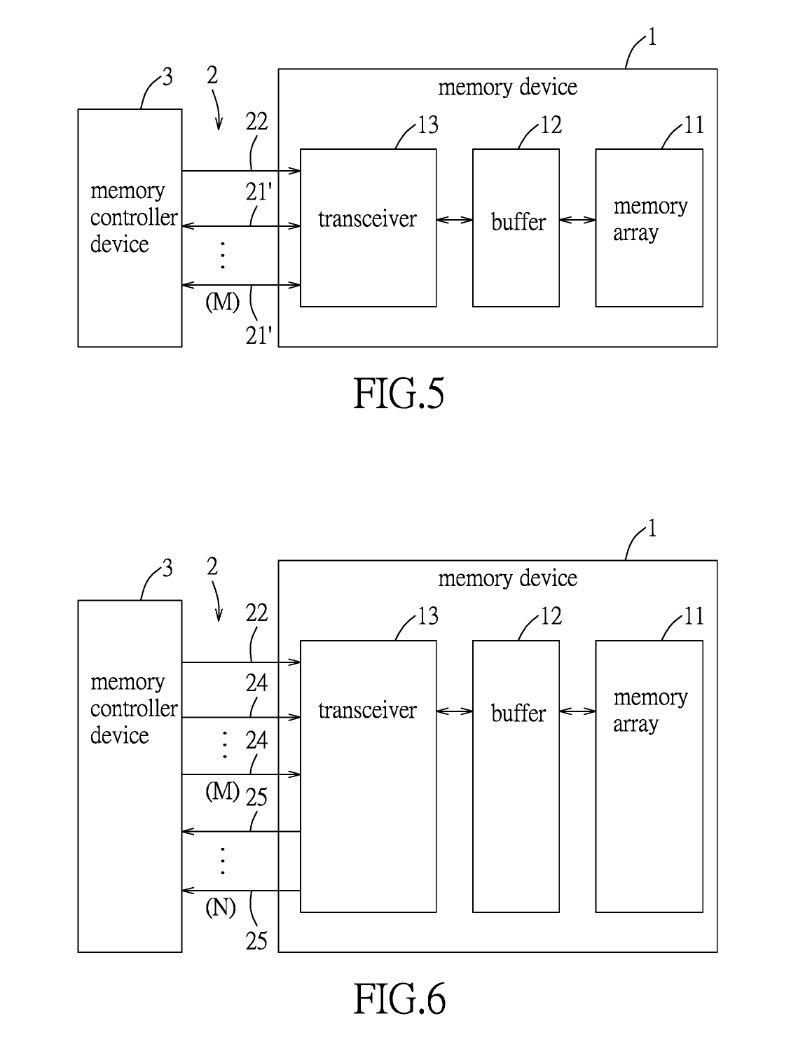

Referring to FIG. 5, a second embodiment of the memory system according to the disclosure is a modification of the first embodiment, and differs from the first embodiment in the configuration of the channel 2 and in the operations of the memory controller device 3 and the transceiver 13.

In the second embodiment, the channel 2 includes a number (M) of serial common bases 21′ to replace the parallel common bus 21 (see FIG. 1), where M is an integer greater than or equal to one (i.e., M≧1). In addition, the memory controller device 3 transmits the write data in synchronization with the write clock signal by using SDR signaling, and the transceiver 13 transmits the read data in synchronization with the read clock signal by using SDR signaling. That is to say, the frequency of the write clock signal equals the write frequency, and the frequency of the read clock signal equals the read frequency.

It should be noted that each serial common bus 21′ includes a conductor (not shown) when single-ended signaling is used by the memory controller device 3 and the transceiver 13, and includes a pair of conductors (not shown) when differential signaling is used by the memory controller device 3 and the transceiver 13.

It should be noted that the write data may be obtained by the memory controller device 3 from encoding original write data, and the read data may be obtained by the transceiver 13 from encoding original read data. For example, two of every ten bits of each of the write data and the read data may be reserved for the encoding, and in such case, the original write data would be transmitted at an effective write bandwidth of 0.8×BWw, and the original read data would be transmitted at an effective read bandwidth of 0.8×BWr.

It should be noted that, in a modification of the second embodiment, the memory controller device 3 may transmit the write data by using self-clocking, and the transceiver 13 may transmit the read data by using self-clocking. In this case the memory controller device 3 may still transmit the write clock signal and the read clock signal through the conductor 22; alternatively, the conductor 22 and the transmission of the write clock signal and the read clock signal may be omitted.

Referring to FIG. 6, a third embodiment of the memory system according to the disclosure is a modification of the first embodiment, and differs from the first embodiment in the configuration of the channel 2 and in the operations of the memory controller device 3 and the transceiver 13.

In the third embodiment, the channel 2 includes a number (M) of serial write buses 24 and a number (N) of serial read buses 25 to replace the parallel common bus 21 (see FIG. 1), where each of M and N is an integer greater than or equal to one (i.e., M≧1 and N≧1), and the write data is transmitted through the serial write buses 24, while the read data is transmitted through the serial read buses 25. That is to say, the write data is transmitted a number (M) of bits at a time, and the read data is transmitted a number (N) of bits at a time. In addition, the read frequency is at least (2×M/N) times the write frequency.

In one exemplary implementation of this embodiment, M may be one, N may be two, the read frequency may equal the write frequency, and the read bandwidth may be twice the write bandwidth. In another exemplary implementation of this embodiment, M may be one, N may be two, the read frequency may be twice the write frequency, and the read bandwidth may be quadruple the write bandwidth. In other embodiments, M may be two, N may be three, the read frequency may equal the write frequency, and the read bandwidth may be 1.5 times the write bandwidth.

Moreover, the memory controller device 3 transmits the write data in synchronization with the write clock signal by using SDR signaling, and the transceiver 13 transmits the read data in synchronization with the read clock signal by using SDR signaling. That is to say, the frequency of the write clock signal equals the write frequency, and the frequency of the read clock signal equals the read frequency.

It should be noted that each serial write bus 24 includes a conductor (not shown) when single-ended signaling is used by the memory controller device 3, and includes a pair of conductors (not shown) when differential signaling is used by the memory controller device 3, and that each serial read bus 25 includes a conductor (not shown) when single-ended signaling is used by the transceiver 13, and includes a pair of conductors (not shown) when differential signaling is used by the transceiver 13.

It should be noted that, in a modification of the third embodiment, the memory controller device 3 may transmit the write data by using self-clocking, and the transceiver 13 may transmit the read data by using self-clocking. In this case, the memory controller device 3 may still transmit the write clock signal and the read clock signal through the conductor 22; alternatively, the conductor 22 and the transmission of the write clock signal and the read clock signal may be omitted.

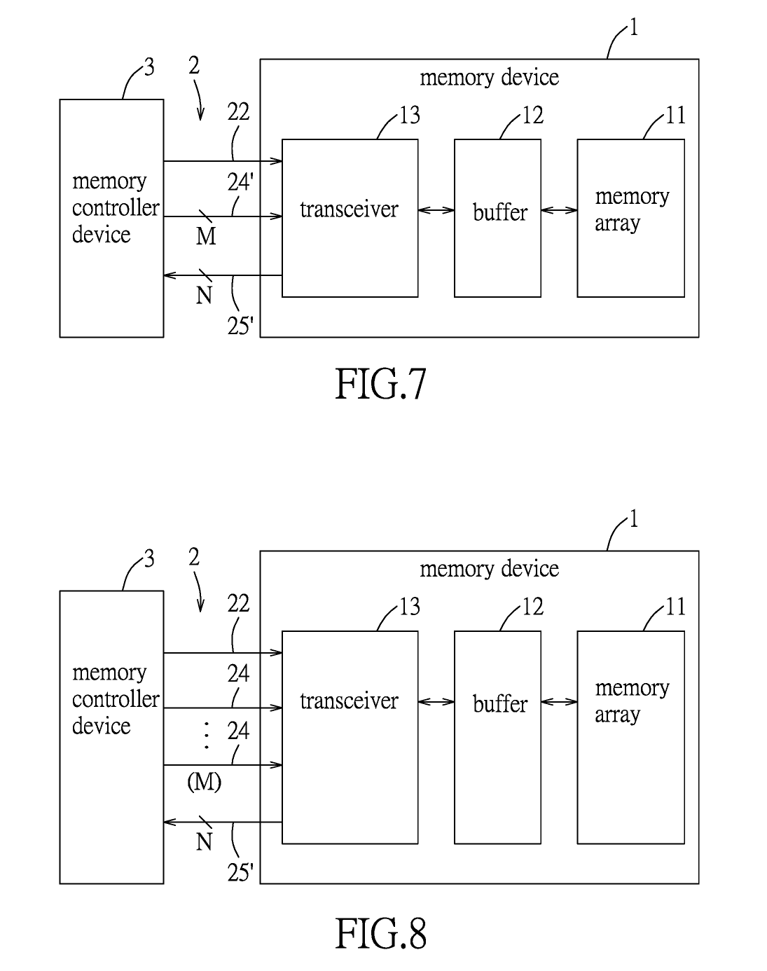

Referring to FIG. 7, a fourth embodiment of the memory system according to the disclosure is a modification of the third embodiment, and differs from the third embodiment in the configuration of the channel 2 and in the operations of the memory controller device 3 and the transceiver 13.

In the fourth embodiment, the channel 2 includes a parallel write bus 24′ that is a number (M) of bits wide to replace the serial write buses 24 (see. FIG. 6), and further includes a parallel read bus 25′ that is a number (N) of bits wide to replace the serial read buses 25 (see. FIG. 6), where each of M and N is an integer greater than one (i.e., M>1 and N>1).

Moreover, the memory controller device 3 transmits the write data in synchronization with the write clock signal by using one of SDR signaling, DDR signaling and QDR signaling, and the transceiver 13 transmits the read data in synchronization with the read clock signal by using one of SDR signaling, DDE signaling and QDR signaling. That is to say, the frequency of the write clock signal equals the write frequency when SDR signaling is used by the memory controller device 3, equals half the write frequency when DDR signaling is used by the memory controller device 3, and equals a quarter of the write frequency when QDR signaling is used by the memory controller device 3, and the frequency of the read clock signal equals the read frequency when SDR signaling is used by the transceiver 13, equals half the read frequency when DDR signaling is used by the transceiver 13, and equals a quarter of the read frequency when QDR signaling is used by the transceiver 13.

It should be noted that the parallel write bus 24′ includes a number (M) of conductors (not shown) when single-ended signaling is used by the memory controller device 3, and includes a number (M) of pairs of conductors (not shown) when differential signaling is used by the memory controller device 3, and that the parallel read bus 25′ includes a number (N) of conductors (not shown) when single-ended signaling is used by the transceiver 13, and includes a number (N) of pairs of conductors (not shown) when differential signaling is used by the transceiver 13.

Referring to FIG. 8, a fifth embodiment of the memory system according to the disclosure is a modification of the third embodiment, and differs from the third embodiment in the configuration of the channel 2 and in the operation of the transceiver 13.

In the fifth embodiment, the channel 2 includes a parallel read bus 25′ that is a number (N) of bits wide to replace the serial read buses 25 (see. FIG. 6), where N is an integer greater than one (i.e., N>1).

Moreover, the transceiver 13 transmits the read data in synchronization with the read clock signal by using one of SDR signaling, DDR signaling and QDR signaling. That is to say, the frequency of the read clock signal equals the read frequency when SDR signaling is used by the transceiver 13, equals half the read frequency when DDR signaling is used by the transceiver 13, and equals a quarter of the read frequency when QDR signaling is used by the transceiver 13.

It should be noted that each serial write bus 24 includes a conductor (not shown) when single-ended signaling is used by the memory controller device 3, and includes a pair of conductors (not shown) when differential signaling is used by the memory controller device 3, and that the parallel read bus 25′ includes a number (N) of conductors (not shown) when single-ended signaling is used by the transceiver 13, and includes a number (N) of pairs of conductors (not shown) when differential signaling is used by the transceiver 13.

It should be noted that, in a modification of the fifth embodiment, the memory controller device 3 may transmit the write data by using self-clocking. In this case, the memory controller device 3 may still transmit the write clock signal through the conductor 22; alternatively, the transmission of the write clock signal may be omitted.

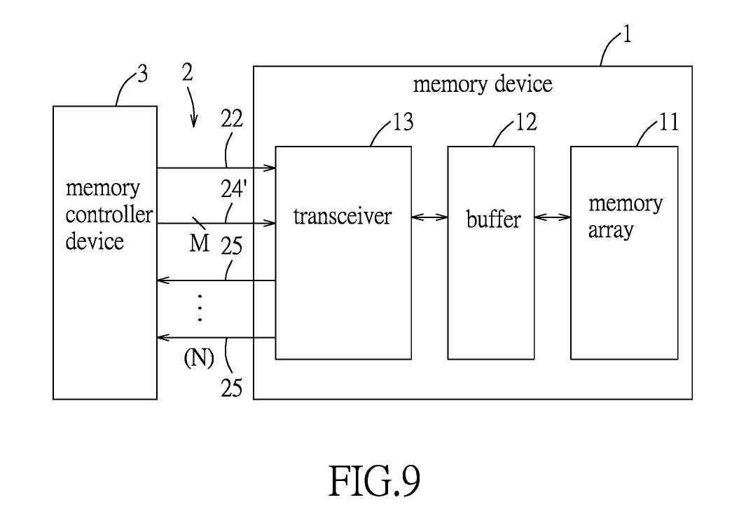

Referring to FIG. 9, a sixth embodiment of the memory system, according to the disclosure is a modification of the third embodiment, and differs from the third embodiment in the configuration of the channel 2 and in the operation of the memory controller device 3.

In the sixth embodiment, the channel 2 includes a parallel write bus 24′ that is a number (M) of bits wide to replace the serial write buses 24 (see. FIG. 6), where M is an integer greater than one (i.e., M>1).

Moreover, the memory controller device 3 transmits the write data in synchronization with the write clock signal by using one of SDR signaling, DDR signaling and QDR signaling. That is to say, the frequency of the write clock signal equals the write frequency when SDR signaling is used by the memory controller device 3, equals half the write frequency when DDR signaling is used by the memory controller device 3, and equals a quarter of the write frequency when QDR signaling is used by the memory controller device 3.

It should be noted that the parallel write bus 24′ includes a number (M) of conductors (not shown) when single-ended signaling is used by the memory controller device 3, and includes a number (M) of pairs of conductors (not shown) when differential signaling is used by the memory controller device 3, and that each serial read bus 25 includes a conductor (not shown) when single-ended signaling is used by the transceiver 13, and includes a pair of conductors (not shown) when differential signaling is used by the transceiver 13.

It should be noted that, in a modification of the sixth embodiment, the transceiver 13 may transmit the read data by using self-clocking. In this case, the memory controller device 3 may still transmit the read clock signal through the conductor 22; alternatively, the transmission of the read clock signal may be omitted.

It should be noted that, for each of the first to sixth embodiments, the memory array 11, the buffer 12, and the transceiver 13 can be on a single chip or be separated among multiple chips. In addition, the memory device 1 and the memory controller device 3 can be on a single chip or be separated among multiple chips. Furthermore, the memory device 1 can be a raw memory device, which is read from and written to according to a physical address of the memory array 11, or be a managed memory device, which is read from and written to according to a translated (logical) address of the memory array 11. The managed memory device may be similar to an embedded MultiMediaCard (eMMC) chip, a Universal Flash Storage (UFS) chip, a BGA (ball grid array) SSD (solid state drive) chip, an M.2 SSD card, or the like, as long as the read bandwidth is greater than the write bandwidth.

It should also be noted that, for each of the first to sixth embodiments, each of the write bandwidth and the read bandwidth refers to an instantaneous bandwidth (as opposed to an average bandwidth) of transferring data that is to be written to or read from the memory array 11 (as opposed to transferring commands and addresses). In addition, the transceiver 13 may support receiving the write data at different bandwidths, a highest one of which is the write bandwidth; and the transceiver 13 may support transmitting the read data at different bandwidths, a highest one of which is the read bandwidth.

It should also be noted that, for each of the first to sixth embodiments, at least one other memory device (not shown) may be added to share the channel 2 with the memory device 1.

In application, the memory system of each of the first to sixth embodiments may be used in a solid state drive (SSD), a cell phone, a general-purpose computer, an embedded system, or the like, and the memory controller device 3 may be an SSD controller, a cell phone processor, a computer processor, an embedded processor, or the like.

In view of the above, for each of the first to sixth embodiments, by transmitting the read data at the read bandwidth that is greater than the write bandwidth, the memory system of the embodiment can have relatively high data transfer efficiency as compared to the memory system that transmits the read data at the read bandwidth which is equal to the write bandwidth.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that the disclosure is not limited to the disclosed embodiments but is intended to cover various arrangements included within the spirit and scope of the broadest interpretation so as to encompass all such modifications and equivalent arrangements.

What is claimed is:

1. A memory system comprising:
a memory device including
a memory array having a read latency, and a write latency that is longer than the read latency,
a buffer coupled to said memory array for two-way data transfer therewith, and
a transceiver coupled to said buffer for two-way data transfer therewith;
a channel coupled to said transceiver; and
a memory controller device coupled to said channel for two-way data transfer with said transceiver therethrough;
wherein said memory controller device transmits write data at a write bandwidth for receipt by said transceiver when said memory controller device is to write the write data to said memory device, and said transceiver transmits read data at a read bandwidth that is greater than the write bandwidth for receipt by said memory controller device when said memory controller device is to read the read data from said memory device.

2. The memory system of claim 1, wherein the write latency is at least twice the read latency, and the read bandwidth is at least twice the write bandwidth.

3. The memory system of claim 2, wherein:
said channel includes a parallel common bus that is a number (M) of bits wide, where M is an integer greater than one;
said memory controller device transmits the write data through said parallel common bus at a write frequency; and
said transceiver transmits the read data through said parallel common bus at a read frequency that is at least twice the write frequency.

4. The memory system of claim 3, wherein:
said memory controller device further transmits a write clock signal and a read clock signal for receipt by said transceiver;
said memory controller device transmits the write data in synchronization with the write clock signal by using one of single data rate (SDR) signaling, double data rate (DDR) signaling and quad data rate (QDR) signaling; and
said transceiver transmits the read data in synchronization with the read clock signal by using one of SDR signaling, DDR signaling and QDR signaling.

5. The memory system of claim 4, wherein, among various settings of a frequency of the read clock signal and an offset of each instance of said memory controller device latching the read data from a corresponding edge of the read clock signal by which a corresponding transmission of the read data is triggered, said memory controller device selects one of the settings that is determined to make the latched read data have an insignificant error rate and to make transmission of the read data fastest, and generates the read clock signal and latches the read data based on the selected one of the settings.

6. The memory system of claim 2, wherein:
said channel includes a number (M) of serial common buses, where M is an integer greater than or equal to one;
said memory controller device transmits the write data through said serial common buses at a write frequency; and
said transceiver transmits the read data through said serial common buses at a read frequency that is at least twice the write frequency.

7. The memory system of claim 6, wherein:
said memory controller device further transmits a write clock signal and a read clock signal for receipt by said transceiver;
said memory controller device transmits the write data in synchronization with the write clock signal by using SDR signaling; and
said transceiver transmits the read data in synchronization with the read clock signal by using SDR signaling.

8. The memory system of claim 6, wherein said transceiver transmits the read data by using self-clocking.

9. The memory system of claim 2, wherein:
said channel includes a number (M) of serial write buses and a number (N) of serial read buses, where each of M and N is an integer greater than or equal, to one;
said memory controller device transmits the write data through said serial write buses at a write frequency; and
said transceiver transmits the read data through said serial read buses at a read frequency that is at least (2×M/N) times the write frequency.

10. The memory system of claim 9, wherein:
said memory controller device further transmits a write clock signal and a read clock signal for receipt by said transceiver;
said memory controller device transmits the write data in synchronization with the write clock signal by using SDR signaling; and
said transceiver transmits the read data in synchronization with the read clock signal by using SDR signaling.

11. The memory system of claim 9, wherein said transceiver transmits the read data by using self-clocking.

12. The memory system of claim 2, wherein:
said channel includes a parallel write bus that is a number (M) of bits wide, and a parallel read bus that is a number (N) of bits wide, where each of M and N is an integer greater than one;
said memory controller device transmits the write data through said parallel write bus at a write frequency; and
said transceiver transmits the read data through said parallel read bus at a read frequency that is at least (2×M/N) times the write frequency.

13. The memory system of claim 12, wherein:
said memory controller device further transmits a write clock signal and a read clock signal for receipt by said transceiver;
said memory controller device transmits the write data in synchronization with the write clock signal by using one of SDR signaling, DDR signaling and QDR signaling; and
said transceiver transmits the read data in synchronization with the read clock signal by using one of SDR signaling, DDR signaling and QDR signaling.

14. The memory system of claim 2, wherein:
said channel includes a number (M) of serial write buses, and a parallel read bus that is a number (N) of bits wide, where M is an integer greater than or equal to one, and where M is an integer greater than one;
said memory controller device transmits the write data through said serial write buses at a write frequency; and
said transceiver transmits the read data through said parallel read bus at a read frequency that is at least (2×M/N) times the write frequency.

15. The memory system of claim 2, wherein:
said channel includes a parallel write bus that is a number (M) of bits wide, and a number (N) of serial read buses, where M is an integer greater than to one, and where N is an integer greater than or equal to one;
said memory controller device transmits the write data through said parallel write bus at a write frequency; and
said transceiver transmits the read data through said serial read buses at a read frequency that is at least (2×M/N) times the write frequency.

16. The memory system of claim 1, wherein said memory device is a raw memory device that is read from and written to according to a physical address of said memory array.

17. The memory system of claim 1, wherein said memory device is a managed memory device that is read from and written to according to a logical address of said memory array.

18. The memory system of claim 1, wherein;
said transceiver supports receiving the write data at different bandwidths, a highest one of which is the write bandwidth; and
said transceiver supports transmitting the read data at different bandwidths, a highest one of which is the read bandwidth.

19. A memory device used to be coupled to a channel that is coupled to a memory controller device, said memory device comprising:
a memory array having a read latency, and a write latency that is longer than the read latency;
a buffer coupled to said memory array for two-way data transfer therewith; and
a transceiver coupled to said buffer for two-way data transfer therewith, and used to be coupled further to the channel for two-way data transfer with the memory controller device therethrough;
wherein said transceiver receives write data from the memory controller device at a write bandwidth when the memory controller device is to write the write data to said memory device, and transmits read data to the memory controller device at a read bandwidth that is greater than the write bandwidth when the memory controller device is to read the read data from said memory device.

20. The memory device of claim 19, wherein the write latency is at least twice the read latency, and the read bandwidth is at least twice the write bandwidth.

21. The memory device of claim 20, wherein said transceiver receives the write data a number (M) of bits at a time and at a write frequency, and transmits the read data a number (M) of bits at a time and at a read frequency that is at least twice the write frequency, where M is an integer greater than or equal to one.

22. The memory device of claim 20, wherein said transceiver receives the write data a number (M) of bits at a time and at a write frequency, and transmits the read data a number (N) of bits at a time and at a read frequency that is at least (2×M/N) times the write frequency, where each of M and N is an integer greater than or equal to one.

23. A method for writing to and reading from a memory device using a memory controller device, the memory device including a memory array, the memory array having a read latency, and a write latency that is longer than the read latency, said method comprising steps of:
transmitting, by the memory controller device, write data to the memory device at a write bandwidth when the memory controller device is to write the write data to the memory device; and
receiving, by the memory controller device, read data from the memory device at a read bandwidth that is greater than the write bandwidth when the memory controller device is to read the read data from the memory device.

24. The method of claim 23, the write latency being at least twice the read latency, wherein the read bandwidth is at least twice the write bandwidth.

25. The method of claim 24, wherein the write data is transmitted a number (M) of bits at a time and at a write frequency, and the read data is received a number (M) of bits at a time and at a read frequency that is at least twice the write frequency, where M is an integer greater than or equal to one.

26. The method of claim 24, wherein the write data is transmitted a number (M) of bits at a time and at a write frequency, and the read data is received a number of bits at a time and at a read frequency that is at least (2×M/N) times the write frequency, where each of M and N is an integer greater than or equal to one.
